(19) United States
(12) Patent Application Publication
(10) Pub. No.: US 2018/0159383 A1
(43) Pub. Date: Jun. 7, 2018

(54) MOTOR AND POWER GENERATOR

(71) Applicant: Shuichi NOWATARI, Kanagawa (JP)

(72) Inventor: Shuichi NOWATARI, Kanagawa (JP)

(21) Appl. No.: 15/577,321

(22) PCT Filed: May 9, 2016
(86) PCT No.: PCT/JP2016/063742

§ 371 Date: Nov. 27, 2017

(30) Foreign Application Priority Data
May 28, 2015 (JP) 2015-108172

(51) Int. Cl. H02K 1/06

(52) U.S. Cl. CPC H02K 1/06; H02K 2201/03

(57) ABSTRACT

The present invention pertains to a motor 1 or a power generator provided with: a stator 2; a rotor 3 that rotates about a rotation shaft 313 so as to be apart from the stator 2 by a space K; and a buffering member 5 located in the space K.

### TECHNICAL FIELD

The present invention relates to a motor and a power generator.

### BACKGROUND ART

A motor commonly includes a stator and a rotor. The rotor rotates about a rotation shaft so as to be apart from the stator by a space. A driving force (a rotary driving force) that rotates the rotor is produced by a magnetic field generated by the stator. The rotation shaft rotates together with rotation of the rotor and outputs a rotary force (for example, see Patent Document 1).

With regard to reducing size and the like of the motor, it is more preferable if the space between the stator and the rotor is smaller. However, if the stator and the rotor come into contact when there is a wobble in rotation of the rotor or the like, this contact may cause damage, breakdown, malfunction or the like. Therefore, in order to prevent contact between the stator and the rotor, the space between the stator and the rotor is specified to be larger or manufacturing precision of the space between the stator and the rotor is improved.
Patent Document 1: Japanese Unexamined Patent Application, Publication No. 2014-147172

### DISCLOSURE OF THE INVENTION

### Problems to be Solved by the Invention

However, in these situations the motor becomes larger or manufacturing costs rise. This problem similarly applies to power generators. There is a desire to suppress the problems caused by the measures taken to prevent contact between stators and rotors in motors and power generators.

An object of the present invention is to provide a motor and power generator that may suppress problems that are caused by measures taken to prevent contact between a stator and a rotor.

### Means for Solving the Problems

The present invention is a motor or a power generator, including: a stator; a rotor that rotates about a rotation shaft so as to be apart from the stator by a space; and a buffering member located in the space.

The buffering member may feature a greater buffering capability than at least one of a portion of the stator that opposes the rotor and a portion of the rotor that opposes the stator.

The buffering member may consist of a fluorine-based resin.

The buffering member may be fixed to at least one of a portion of the stator that opposes the rotor and a portion of the rotor that opposes the stator.

A shape of the buffering member may be tubular or annular.

### Effects of the Invention

According to the present invention, a motor and power generator may be provided that may suppress problems that are caused by measures taken to prevent contact between a stator and a rotor.

### BRIEF DESCRIPTION OF THE DRAWINGS

FIG. 1A is a side sectional diagram illustrating a motor 1 according to a first embodiment of the present invention.

FIG. 1B is a lateral sectional diagram illustrating the motor 1 according to the first embodiment of the present invention.

FIG. 2A is a side sectional diagram illustrating a motor 1A according to a second embodiment of the present invention.

FIG. 2B is a lateral sectional diagram illustrating the motor 1A according to the second embodiment of the present invention.

FIG. 3A is a side sectional diagram illustrating a motor 1B according to a third embodiment of the present invention.

FIG. 3B is a lateral sectional diagram illustrating the motor 1B according to the third embodiment of the present invention.

FIG. 4A is a side sectional diagram illustrating a motor 101 according to a fourth embodiment of the present invention.

FIG. 4B is a sectional diagram, cut along line B-B in FIG. 4A, illustrating the motor 101 according to the fourth embodiment of the present invention.

FIG. 5 is a side sectional diagram (corresponding to FIG. 4A) illustrating a motor 101 according to a fifth embodiment of the present invention.

### PREFERRED MODE FOR CARRYING OUT THE INVENTION

### First Embodiment

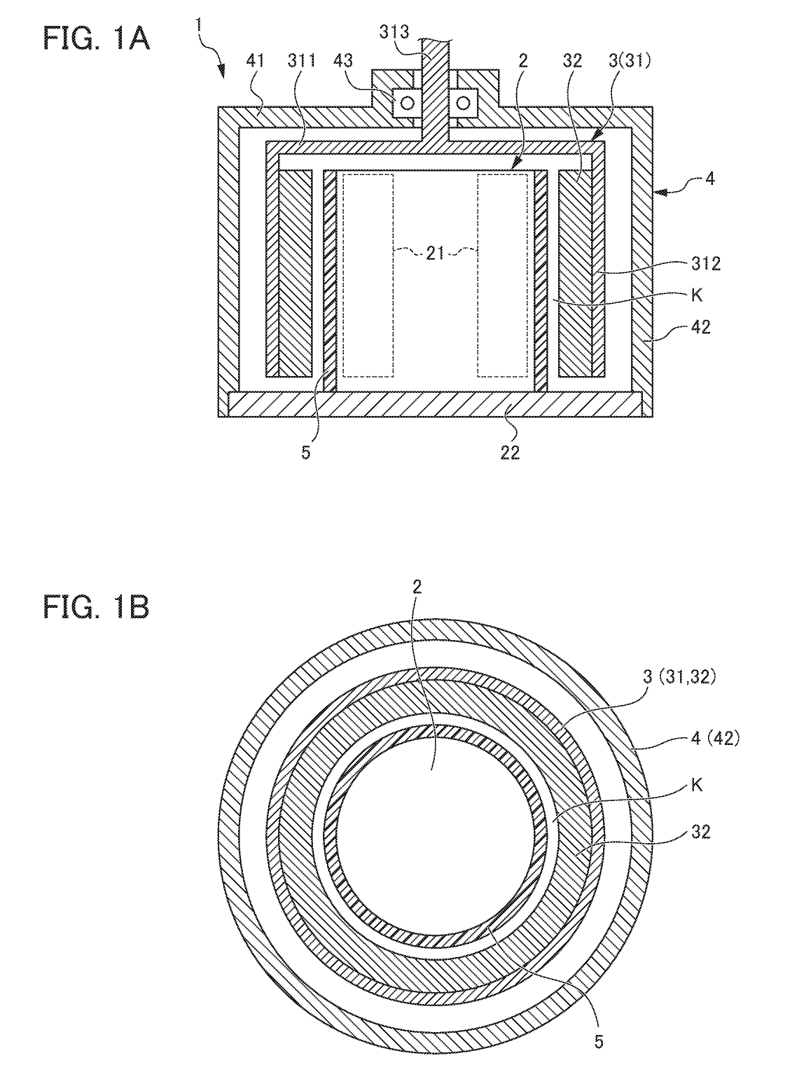

Below, a motor according to a first embodiment of the present invention is described. FIG. 1A is a side sectional diagram illustrating a motor 1 according to the first embodiment of the present invention. FIG. 1B is a lateral sectional diagram illustrating the motor 1 according to the first embodiment of the present invention.

As illustrated in FIG. 1A and FIG. 1B, the motor 1 according to the first embodiment of the present invention is an outer rotor-type motor provided with an outer case. The motor 1 is provided with a stator 2, a rotor 3, an outer case 4 and a buffering member 5. The motor 1 according to the first embodiment is a radial gap motor in which the orientation of a space K between the stator 2 and the rotor 3 is a radial direction (the left-right direction in FIG. 1A) that is orthogonal to an axial direction of the rotor 3 (the up-down direction in FIG. 1A).

The stator 2 is provided with stator cores (not shown in the drawings), a stator coil 21, a base portion 22 and so forth. The stator 2 generates magnetic fields for producing a driving force (a rotary driving force) that rotates the rotor 3. The stator 2 is disposed to be spaced to the inner side of the rotor 3 by the space K. The stator cores are structured by plural layers of a magnetic material in plate shapes, such as magnetic steel plates or the like. The stator cores extend in the radial direction so as to be separated from the center of rotation. The stator cores are plurally provided, spaced at intervals in the circumferential direction. The stator coil 21 is wound round the stator cores. Magnetic force is generated when the stator coil 21 is electrified.

The base portion 22 is a base for the stator 2. The outer case 4 is fixed to the base portion 22. The stator cores (not shown in the drawings), the stator coil 21 and the rotor 3 are enclosed by the base portion 22 and the outer case 4. The structure and external shape of the stator 2 are not limited provided magnetic fields for producing a driving force (a rotary driving force) that rotates the rotor 3 may be generated and rotation of the outer rotor 3 is not blocked. In FIG. 1A and FIG. 1B, the external shape of the stator 2 is depicted simply as a circular rod shape.

The rotor 3 rotates about a rotor shaft 313, which is a rotation shaft, so as to be apart from the stator 2 by the space K. The rotor 3 is disposed at the outer side of the stator 2, at the inner side of the outer case 4. The rotor 3 is provided with a rotor frame 31 and a rotor magnet 32. The rotor frame 31 is provided with a rotor top face portion 311 in a circular plate shape, a rotor periphery wall portion 312 in a circular tube shape, and the rotor shaft 313. The rotor periphery wall portion 312 extends in the axial direction (the up-down direction in FIG. 1A) from the periphery edge of the rotor top face portion 311.

One end side in the axial direction of the rotor frame 31 (the upper side in FIG. 1A) is closed off by the rotor top face portion 311. The circular tube shape of the rotor periphery wall portion 312 is centered on the center of rotation of the rotor 3. The rotor shaft 313 extends in the axial direction from the center of the rotor top face portion 311 and is retained in a freely rotatable state by a bearing 43 of the outer case 4. The other end side in the axial direction of the rotor frame 31 (the lower side in FIG. 1A) is open.

The rotor magnet 32 is fixed to the inner side of the rotor periphery wall portion 312 of the rotor frame 31. The rotor magnet 32 is magnetized in a state in which the polarity reverses to alternate N, S, N, S along the circumferential direction. The space K in the direction (the radial direction) orthogonal to the axial direction of the rotor 3 is formed between the exterior of the stator 2 and the interior of the rotor magnet 32.

When the stator coil 21 of the stator 2 is electrified, magnetic fields are generated in the stator 2 for producing a driving force (a rotary driving force) that rotates the rotor 3. As a result, the rotor 3 rotates about the rotor shaft 313, at the outer side of the stator 2 but at the inner side of the outer case 4. Rotary force is outputted by the rotation of the rotor 3.

The outer case 4 is fabricated of metal. The outer case 4 is provided with a case top face portion 41 in a circular plate shape and a case periphery wall portion 42 that extends in the axial direction from a periphery edge of the case top face portion 41. One end side in the axial direction of the outer case 4 (the upper side in FIG. 1A) is substantially closed off by the case top face portion 41. The case periphery wall portion 42 has a circular tube shape centered on the center of rotation of the rotor 3. In a standalone state of the outer case 4, the other end side in the axial direction of the outer case 4 (the lower side in FIG. 1A) is open. The other end side in the axial direction of the outer case 4 is fixed to the base portion 22 of the stator 2.

The bearing 43 is provided at the center of the case top face portion 41 of the outer case 4. The bearing 43 retains the rotor shaft 313 in the freely rotatable state. The bearing 43 may be a rolling bearing or may be a sliding bearing.

The buffering member 5 is located in the space K. The buffering member 5 has a greater buffering capability than a portion of the stator 2 that opposes the rotor 3. The portion of the stator 2 that opposes the rotor 3 is regions of the stator 2 that would oppose the rotor 3 if the buffering member 5 were not present. The greater buffering capability is realized by the buffering member 5 being constituted of a material that is relatively soft and has a lower coefficient of friction than the portion of the stator 2 that opposes the rotor 3. For example, the buffering member 5 is constituted of a fluorine-based resin.

The buffering member 5 is fixed to the portion of the stator 2 that opposes the rotor 3. In the first embodiment, the buffering member 5 has a circular tube shape. An outer periphery of the stator 2 is uneven. An inner periphery face of the buffering member 5 with the circular tube shape is principally abutted against portions of the outer periphery of the stator 2 that protrude greatly (for example, protruding end portions of the stator cores). The buffering member 5 need not be continuous in the circumferential direction; the buffering member 5 may be located at intervals in the circumferential direction.

A thickness of the buffering member 5 is preferably thinner within a range producing the buffering action. For example, the thickness is preferably 1 to 3 mm, and more preferably 1 to 2 mm. A size of the space K taking account of the presence of the buffering member 5 (a size of the space K in the radial direction between the exterior of the buffering member 5 and the interior of the rotor magnet 32) is preferably 1 to 3 mm, and more preferably 1 to 2 mm.

A fluorine-based resin that is used is, for example, polytetrafluoroethylene (PTFE), perfluoroalkoxy alkane (PFA), ethylene tetrafluoroethylene copolymer (ETFE), polyvinylidene fluoride (PVDF), or ethylene chlorotrifluoroethylene copolymer (ECTFE). Beside fluorine-based resins, foam plastics such as hard polyurethane foams and the like and carbon fiber-reinforced plastics (CFRP) can be mentioned.

According to the first embodiment of the motor 1, for example, the following effects are provided. The motor 1 according to the first embodiment is provided with the buffering member 5 located in the space K. In particular, the buffering member 5 features greater buffering capability than the portion of the stator 2 that opposes the rotor 3. Therefore, according to the first embodiment of the motor 1, even if the stator 2 and the rotor 3 act to make contact when there is a wobble in rotation of the rotor 3 or the like, the contact is moderated by the buffering capability of the buffering member 5, and the rotor 3 is restored to suitable rotation. Thus, damage, breakdowns, malfunctions and the like may be suppressed. Accordingly, specifying a larger space K between the stator 2 and the rotor 3 or improving manufacturing precision of the space K between the stator 2 and the rotor 3 in order to prevent contact between the stator 2 and the rotor 3 may be avoided. As a result, the space K between the stator 2 and the rotor 3 may be made smaller and the motor 1 may be reduced in size.

Because the buffering member 5 constituted of a fluorine-based resin is relatively soft with a low coefficient of friction and features a suitably great buffering capability, the effects described above may be enhanced. Because the buffering member 5 is fixed to the portion of the stator 2 that opposes the rotor 3, the buffering member 5 may be reliably located. Because the buffering member 5 is tubular, fabrication thereof and location in the space K are simple.

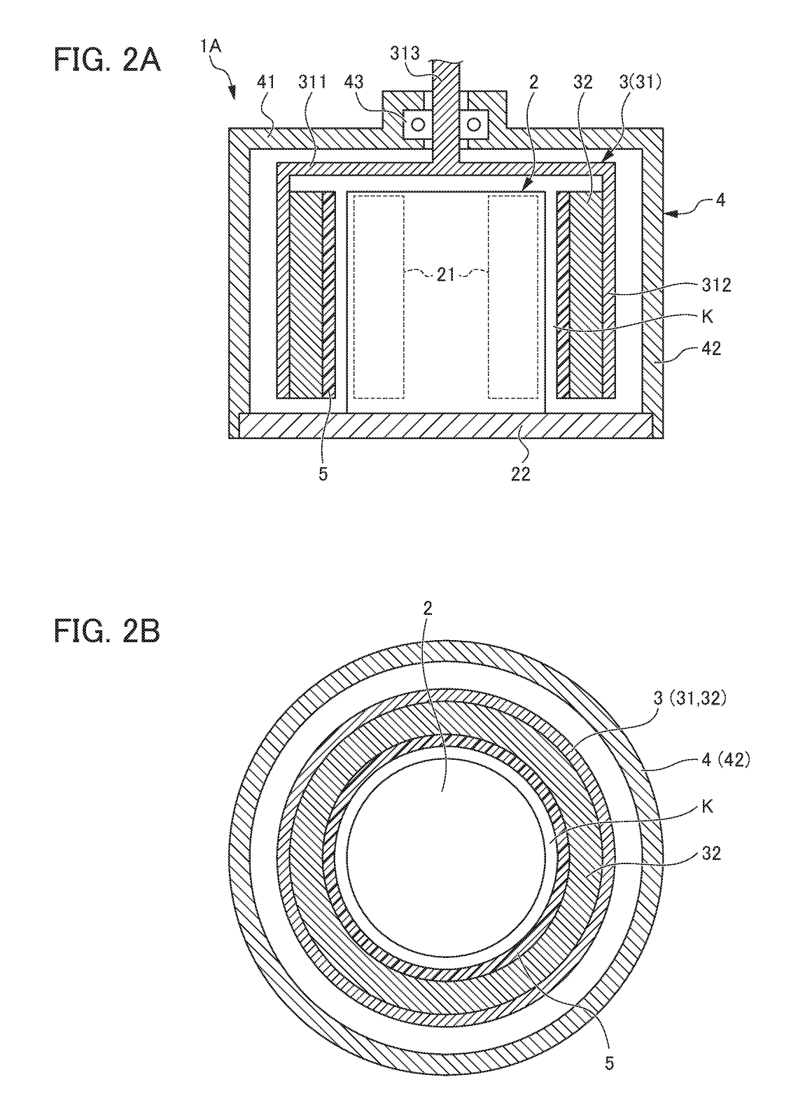

Now, a second embodiment of the present invention is described. FIG. 2A is a side sectional diagram illustrating a motor 1A according to the second embodiment of the present invention. FIG. 2B is a lateral sectional diagram illustrating the motor 1A according to the second embodiment of the present invention. In the second and subsequent embodiments, descriptions are principally given with regard to points that differ from the first embodiment. Structures that are the same as in the first embodiment are assigned the same reference numerals and detailed descriptions thereof are not given. In the second and subsequent embodiments, the descriptions of the first embodiment may be applied as appropriate to points that are not specifically described. The second and subsequent embodiments provide the same effects as the first embodiment.

### Second Embodiment

In the first embodiment, the buffering member 5 is fixed to the portion of the stator 2 that opposes the rotor 3. In contrast, as illustrated in FIG. 2A and FIG. 2B, in a motor 1A according to the second embodiment, the buffering member 5 is fixed to a portion of the rotor 3 that opposes the stator 2. That is, in the second embodiment the buffering member 5 is not provided at the stator 2 side but provided at the rotor 3 side. Thus, the buffering member 5 rotates together with the rotor 3.

### Third Embodiment

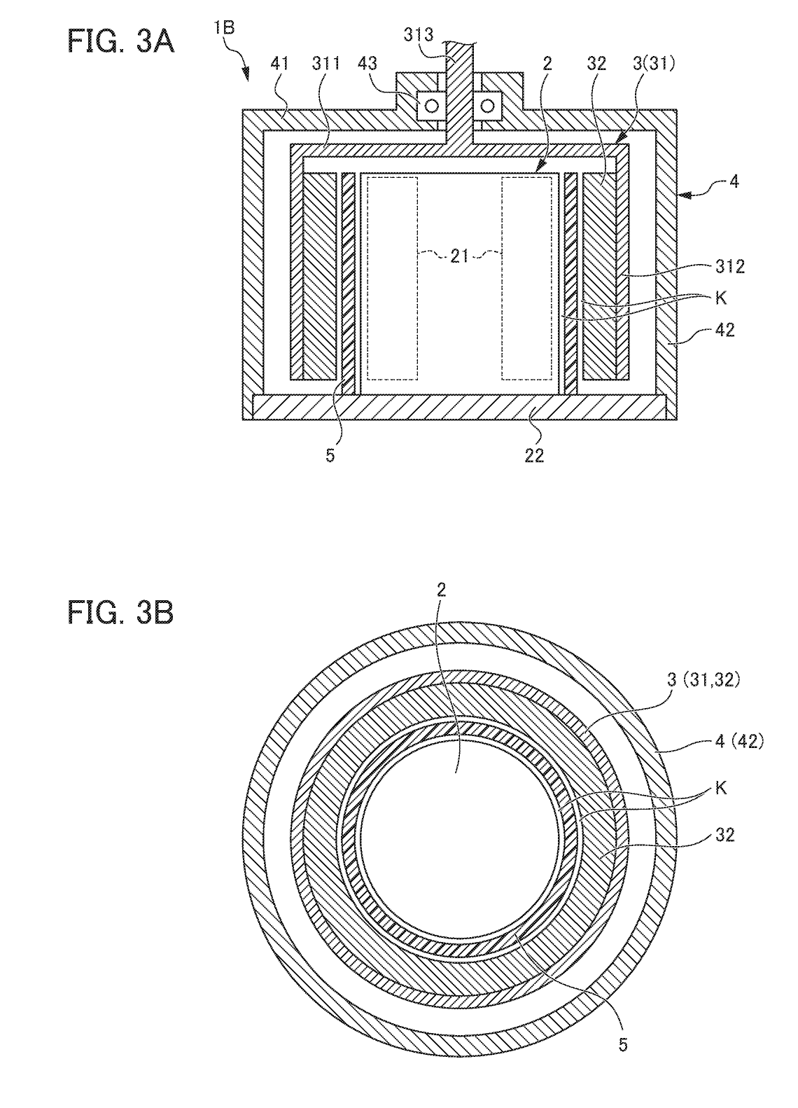

A motor 1B according to a third embodiment is described. FIG. 3A is a side sectional diagram illustrating the motor 1B according to the third embodiment of the present invention. FIG. 3B is a lateral sectional diagram illustrating the motor 1B according to the third embodiment of the present invention. As illustrated in FIG. 3A and FIG. 3B, in the motor 1B according to the third embodiment, the buffering member 5 is located in the space K. To be specific, the buffering member 5 is disposed at a location at which, during usual rotation of the rotor 3, the buffering member 5 does not come into contact with either the portion of the stator 2 that opposes the rotor 3 or the portion of the rotor 3 that opposes the stator 2. The buffering member 5 is fixed to a base portion 122.

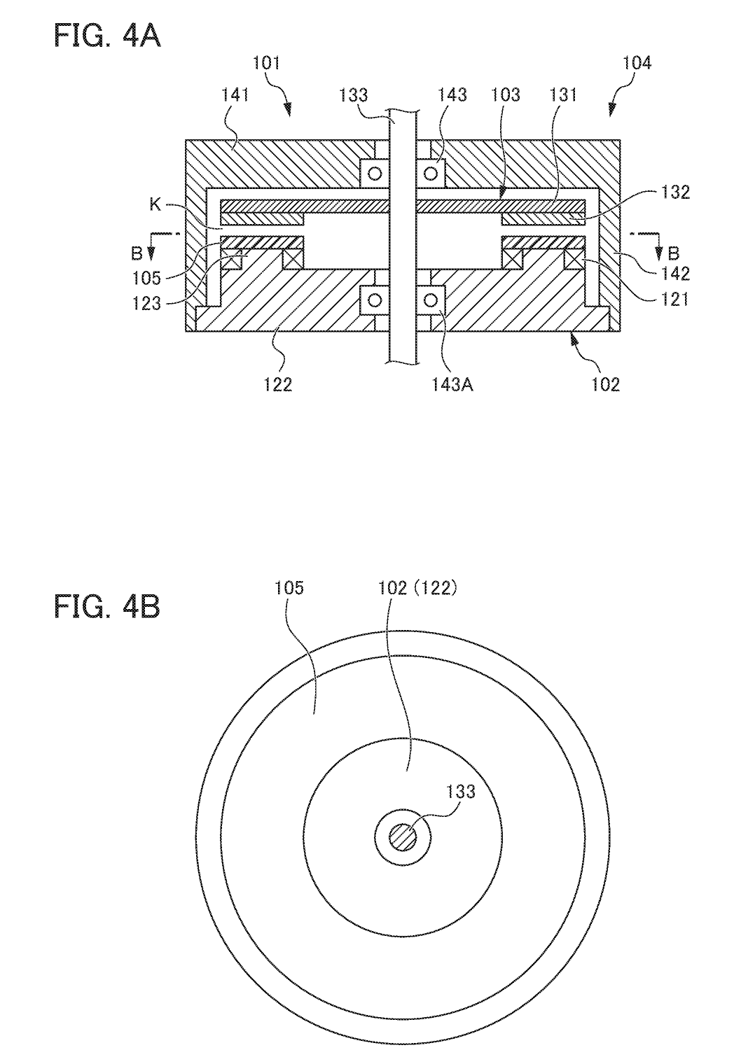

Now, a motor 101 according to a fourth embodiment of the present invention is described. FIG. 4A is a side sectional diagram illustrating the motor 101 according to the fourth embodiment of the present invention. FIG. 4B is a sectional diagram, cut along line B-B in FIG. 4A, illustrating the motor 101 according to the fourth embodiment of the present invention. In the fourth embodiment, descriptions are principally given with regard to points that differ from the first embodiment. Structures that are the same as in the first embodiment are assigned reference numerals incremented by +100. In the fourth embodiment, the descriptions of the first embodiment may be applied as appropriate to points that are not specifically described. The fourth embodiment provides the same effects as the first embodiment.

### Fourth Embodiment

The motor 1 according to the first embodiment is a radial gap motor in which the orientation of the space K between the stator 2 and the rotor 3 is the radial direction orthogonal to the axial direction of the rotor 3. In contrast, as illustrated in FIG. 4A and FIG. 4B, the motor 101 according to the fourth embodiment is an axial gap motor in which the orientation of a space K between a stator 102 and a rotor 103 is an axial direction of the rotor 103.

As illustrated in FIG. 4A and FIG. 4B, the motor 101 according to the fourth embodiment of the present invention is provided with the stator 102, the rotor 103, an outer case 104 and a buffering member 105. The space K between the stator 102 and the rotor 103 is parallel with the axial direction of the rotor 103.

The stator 102 is provided with stator cores 123, a stator coil 121 and so forth. The stator 102 generates magnetic fields for producing a driving force (a rotary driving force) that rotates the rotor 103. The stator 102 is disposed to be spaced apart from a portion of the rotor 103 that opposes the stator 102 by the space K. The stator cores 123 are structured by plural layers of a magnetic material in plate shapes, such as magnetic steel plates or the like. The stator cores 123 extend in the axial direction of the rotor 103. The stator cores 123 are plurally provided, spaced at intervals in the circumferential direction. The stator coil 121 is wound round the stator cores 123. Magnetic force is generated when the stator coil 121 is electrified.

The base portion 122 is a base for the stator 102. The outer case 104 is fixed to the base portion 122. The stator cores 123, the stator coil 121 and the rotor 103 are enclosed by the base portion 122 and the outer case 104. A bearing 143A is provided at the base portion 122. The structure and external shape of the stator 102 are not limited provided magnetic fields for producing a driving force (a rotary driving force) that rotates the rotor 103 may be generated and rotation of the rotor 103 is not blocked.

The rotor 103 rotates about a rotor shaft 133, which is a rotation shaft, so as to be apart from the stator 102 by the space K. The rotor 103 is disposed between a case top face portion 141 of the outer case 104 and the stator 102. The rotor 103 is provided with a rotor frame 131, a rotor magnet 132 and the rotor shaft 133. The rotor frame 131 has a circular plate shape.

The rotor magnet 132 is fixed to a portion of the rotor frame 131 that opposes the stator cores 123 and the stator coil 121. The rotor magnet 132 is magnetized in a state in which the polarity reverses to alternate N, S, N, S along the circumferential direction.

The rotor shaft 133 penetrates through the center of the rotor frame 131. The rotor shaft 133 extends in the axial direction and is fixed to the rotor frame 131. The rotor shaft 133 is retained in a freely rotatable state by a bearing 143 of the outer case 104 and the bearing 143A of the base portion 122 of the stator 102.

Thus, when the stator coil 121 of the stator 102 is electrified, magnetic fields are generated in the stator 102 for producing a driving force (a rotary driving force) that rotates the rotor 103. As a result, the rotor 103 rotates about the rotor shaft 133 between the case top face portion 141 of the outer case 104 and the stator 102. Rotary force is outputted by the rotation of the rotor 103.

The outer case 104 is fabricated of metal. The outer case 104 is provided with the case top face portion 141 in a circular plate shape and a case periphery wall portion 142 that extends in the axial direction from a periphery edge of the case top face portion 141. One end side in the axial direction of the outer case 104 (the upper side in FIG. 4A) is substantially closed off by the case top face portion 141. The case periphery wall portion 142 has a circular tube shape centered on the center of rotation of the rotor 103. The other end side in the axial direction of the outer case 104 (the lower side in FIG. 4A) is open and is fixed to the base portion 122 of the stator 102.

The bearing 143 is provided at the center of the case top face portion 141 of the outer case 104. Together with the bearing 143A of the base portion 122 of the stator 102, the bearing 143 retains the rotor shaft 133 in the freely rotatable state. The bearings 143 and 143A may be rolling bearings and may be sliding bearings.

The buffering member 105 is located in the space K. The buffering member 105 has a greater buffering capability than a portion of the stator 102 that opposes the rotor 103.

The buffering member 105 is fixed to the portion of the stator 102 that opposes the rotor 103. In this fourth embodiment, the buffering member 105 has an annular shape (a circular plate shape from which a central portion is removed). An outer periphery of the stator 102 is uneven. The buffering member 105 with the annular shape is principally abutted against portions of the stator 102 that protrude greatly (for example, protruding end portions of the stator cores 123). The buffering member 105 need not be continuous in the circumferential direction; the buffering member 105 may be located at intervals in the circumferential direction.

A thickness of the buffering member 105 is preferably thinner within a range producing the buffering action. For example, the thickness is preferably 1 to 3 mm, and more preferably 1 to 2 mm. A size of the space K taking account of the presence of the buffering member 105 (a size of the space K in the axial direction between the exterior of the buffering member 105 and the interior of the rotor magnet 132) is preferably 1 to 3 mm, and more preferably 1 to 2 mm.

### Fifth Embodiment

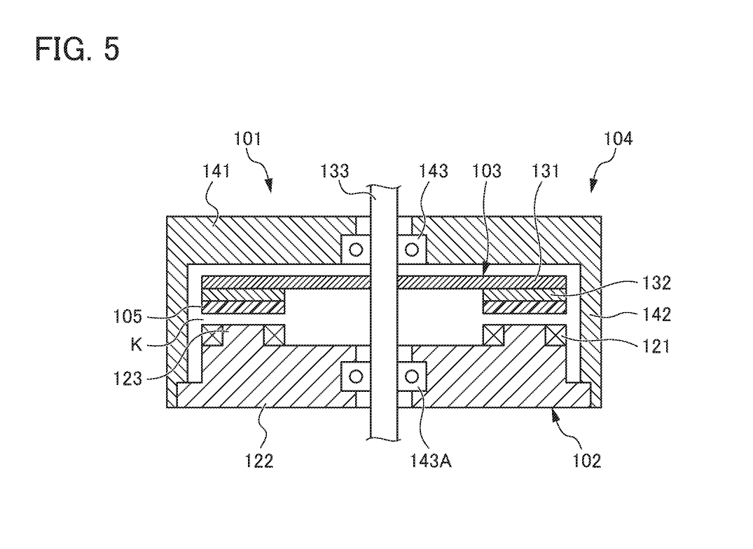

A motor 101 according to a fifth embodiment is described. FIG. 5 is a side sectional diagram (corresponding to FIG. 4A) illustrating the motor 101 according to the fifth embodiment of the present invention. In the fourth embodiment, the buffering member 105 is fixed to the portion of the stator 102 that opposes the rotor 103. In contrast, in the motor 101 according to the fifth embodiment as illustrated in FIG. 5, the buffering member 105 is fixed to a portion of the rotor 103 that opposes the stator 102. That is, in the fifth embodiment, the buffering member 105 is not provided at the stator 102 side but provided at the rotor 103 side. Thus, the buffering member 105 rotates together with the rotor 103.

Preferred embodiments of the present invention are described hereabove, but the present invention is not limited by the embodiments described above and may be embodied in various modes. For example, the structures of the embodiments described above may be combined as appropriate. The structure of the motor is not particularly limited. The motor may be an inner rotor-type motor. The motor may be, for example, a brushed DC motor, a permanent magnet synchronous motor (a brushless DC motor) a three-phase induction motor, a single-phase induction motor (a universal motor) or a stepper motor.

The buffering member 5 may be fixed to both the portion of the stator 2 that opposes the rotor 3 and the portion of the rotor 3 that opposes the stator 2. The buffering member 5 may be structured by one or a plural number of sheets (rather than being a tube shape or an annular shape).

In the embodiments described above, the present invention is applied to a motor, but this is not limiting. Because the structure of a power generator is basically similar to the structure of a motor, the present invention may also be applied to a power generator. In a power generator, electricity is generated by the rotor being rotated by an applied rotary force.

### EXPLANATION OF REFERENCE NUMERALS

1, 1A, 1B, 101 Motor
2, 102 Stator
3, 103 Rotor
4, 104 Outer case
5, 105 Buffering member
21,121 Stator coil
32, 132 Rotor magnet
133 Rotor shaft (rotation shaft)
313 Rotor shaft (rotation shaft)
K Space

1. A motor or a power generator, comprising: a stator;
a rotor that rotates about a rotation shaft so as to be apart from the stator by a space; and
a buffering member located in the space,
wherein the buffering member includes one of the following structures (a) to (c):
(a) the buffering member is fixed to a portion of the stator that opposes the rotor and is not fixed to a portion of the rotor that opposes the stator;
(b) the buffering member is fixed to a portion of the rotor that opposes the stator and is not fixed to a portion of the stator that opposes the rotor; and
(c) the buffering member is located in the space at a location at which, during usual rotation of the rotor, the buffering member does not come into contact with either the portion of the stator that opposes the rotor or the portion of the rotor that opposes the stator.

2. The motor or power generator according to claim 1, wherein the buffering member features a greater buffering capability than at least one of a portion of the stator that opposes the rotor and a portion of the rotor that opposes the stator.

3. The motor or power generator according to claim 1, wherein the buffering member consists of a fluorine-based resin.

4. (canceled)

5. The motor or power generator according to claim 1, wherein a shape of the buffering member is tubular or annular.
